(19) United States
(12) Patent Application Publication
(10) Pub. No.: US 2009/0047640 A1
(43) Pub. Date: Feb. 19, 2009

(54) Teaching the letter shapes, their basic sounds and basic reading and writing

(76) Inventors: Mesrop Khachatrian, Pasadena, CA (US); Jasmine Khachatrian, Arcadia, CA (US)

Correspondence Address: Mesrop Khachatrian, Apt. 208, 333 N. Hill Ave., Pasadena, CA, 91106, US

(21) Appl. No.: 12/228,375

(22) Filed: Aug. 12, 2008

Related U.S. Application Data
(60) Provisional application No. 60/964,743, filed on Aug. 16, 2007.

(51) Int. Cl. G09B 1/00

(52) U.S. Cl. 434/159

(57) ABSTRACT

The letter shapes and sounds are abstract for children. The present Invention eliminates the abstract nature of the letter shapes and sounds, makes the learning material extremely easy and fun by inventing tangible bases for the letter shapes and their basic sounds. The Invention comprises 26 flash cards with 26 invented letter shaped animals and objects on them. Each animal or object physically looks like a letter and the first sound of that animal or object name and the basic sound of that letter are the same. Learning the animal or the object shape and the first sound of the animal/object name as the short version of the animal/object name, the child actually learns the shape and the basic sound of the letter.

### CROSS-REFERENCE TO RELATED APPLICATIONS

This application claims the benefit of Provisional Patent Application, Ser. No. 60/964,743 filed on Aug. 16, 2007 by the present inventors, which is incorporated by reference.

### BACKGROUND OF THE INVENTION

The present Invention relates to improving teaching the letter shapes, their basic sounds and basic reading and writing in Kindergarten, and relates specifically to teaching the same program to Pre-Kindergarten children proving that teaching the letter shapes, their basic sounds and basic reading and writing to Pre-Kindergarten children is possible and can be done easily and without pressure.

Many inventions, including those with the following patent numbers: U.S. Pat. Nos. 7,270,546, 7,201,317, 7,111,774, 7,066,737, 7,004,758, 6,796,798, 6,814,579, 6,669,478, 7,018,210, 6,869,287, 6,322,367, 4,778,392, 5,108,113 have been done which attempt to teach reading and writing to young children. Some improvement has been made with regard to this, but teaching reading and writing to young children is still a problem in Kindergarten and it is simply impossible in Pre-Kindergarten.

In order to read a word, children need to (a) recognize the letter shapes of the word, (b) to say the basic sounds of those shapes one by one and (c) to blend those sounds together. In order to write a word, they need to (a) segment the word into its sounds and write the sound symbols (letters) on paper. Sound blending and word segmenting are two skills which are easy to teach because their learning is based on hearing and needs only practice. But the letter shapes and their basic sounds are extremely difficult to learn because they are abstract to young children.

### BRIEF SUMMARY OF THE INVENTION

The problem could have been solved if one had eliminated the abstract nature of the letter shapes and their basic sounds by having invented tangible bases for them so that the child could see that the letter shapes and their basic sounds are those of tangible things which are familiar and make sense to them as children. That is exactly what we have done.

We have invented 26 letter shaped animals/objects. Each animal/object physically looks like a letter and the first sound of each animal/object name and the basic sound of the letter that each animal looks like are the same. For example:

This invented alligator [symbol] has almost the same shape as this letter [symbol] Besides, the first sound of the word alligator is [a] and the basic sound of that letter is also [a]. Children are taught that both of the pictures are the same animal and they have the same shape and the same name. Children are also taught that both “animals” have a long name (alligator) and a short name [a] (which is the first sound of the word alligator). Learning the black “animal's” shape and its short name [a] children actually learn the shape and the basic sound of the letter [symbol] As you see, the Invention makes learning extremely easy, because instead of learning directly the letter shapes and their basic sounds (which are abstract and therefore impossible to learn), children learn them indirectly, by learning the shapes and the short names of animals or objects (which are tangible, make sense to children, fun, therefore easy to learn).

### BRIEF DESCRIPTION OF THE DRAWINGS

FIG. 1 and FIG. 1A (alligator) teach the shape and the basic sound [a] of the letter a.

FIG. 2 and FIG. 2A (bear) teach the shape and the basic sound [b] of the letter b.

FIG. 3 and FIG. 3A (elephant) teach the shape and the basic sound [e] of the letter e.

FIG. 4 and FIG. 4A (caterpillar) teach the shape and the basic sound [k] of the letter k.

FIG. 5 and FIG. 5A (fish) teach the shape and the basic sound [f] of the letter f.

FIG. 6 and FIG. 6A (duck) teach the shape and the basic sound [d] of the letter d.

FIG. 7 and FIG. 7A (horse) teach the shape and the basic sound [h] of the letter h.

FIG. 8 and FIG. 8A (gorilla) teach the shape and the basic sound [g] of the letter g.

FIG. 9 and FIG. 9A (olive) teach the shape and the basic sound [o] of the letter o.

FIG. 10 and FIG. 10A (queen) teach the shape and the basic sound [k] of the letter q.

FIG. 11 and FIG. 11A (parrot) teach the shape and the basic sound [p] of the letter p.

FIG. 12 and FIG. 12A (uncle) teach the shape and the basic sound [u] of the letter u.

FIG. 13 and FIG. 13A (worm) teach the shape and the basic sound [w] of the letter w.

FIG. 14 and FIG. 14A (jelly beans) teach the shape and the basic sound [j] of the letter j.

FIG. 15 and FIG. 15A (yani=a boy's name) teach the shape and the basic sound [Y] of the letter y.

FIG. 16 and FIG. 16A (lizard) teach the shape and the basic sound [l] of the letter 1.

FIG. 17 and FIG. 17A (king) teach the shape and the basic sound [k] of the letter k.

FIG. 18 and FIG. 18A (tiger) teach the shape and the basic sound [t] of the letter t.

FIG. 19 and FIG. 19A (fox) teach the shape and the last two sounds [ks] of the letter f.

FIG. 20 and FIG. 20A (zebra) teach the shape and the basic sound [z] of the letter z.

FIG. 21 and FIG. 21A (nan=a girl's name) teach the shape and the basic sound [n] of the letter n.

FIG. 22 and FIG. 22A (rabbit) teach the shape and the basic sound [r] of the letter r.

FIG. 23 and FIG. 23A (snake) teach the shape and the basic sound [s] of the letter s.

FIG. 24 and FIG. 24A (vulture) teach the shape and the basic sound [v] of the letter v.

FIG. 25 and FIG. 25A (monkey) teach the shape and the basic sound [m] of the letter m.

FIG. 26 and FIG. 26A (insect) teach the shape and the basic sound [i] of the letter i.

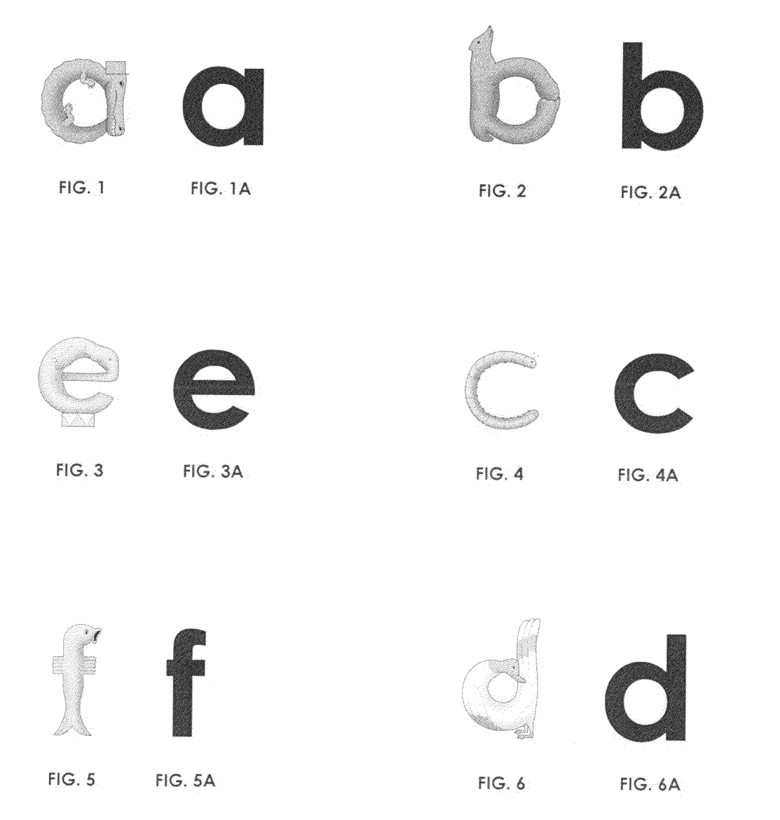

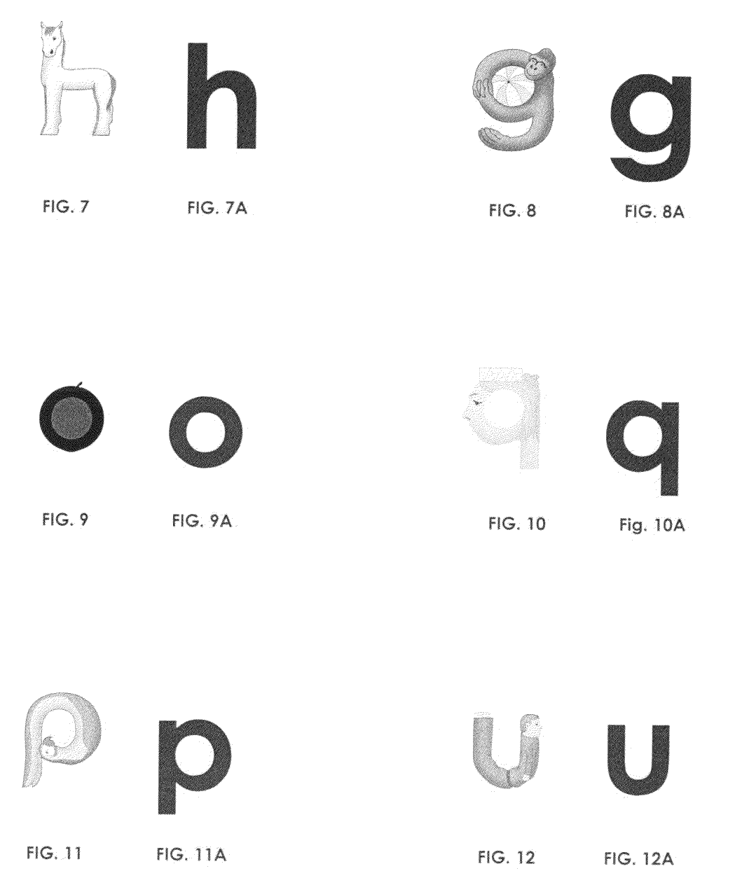

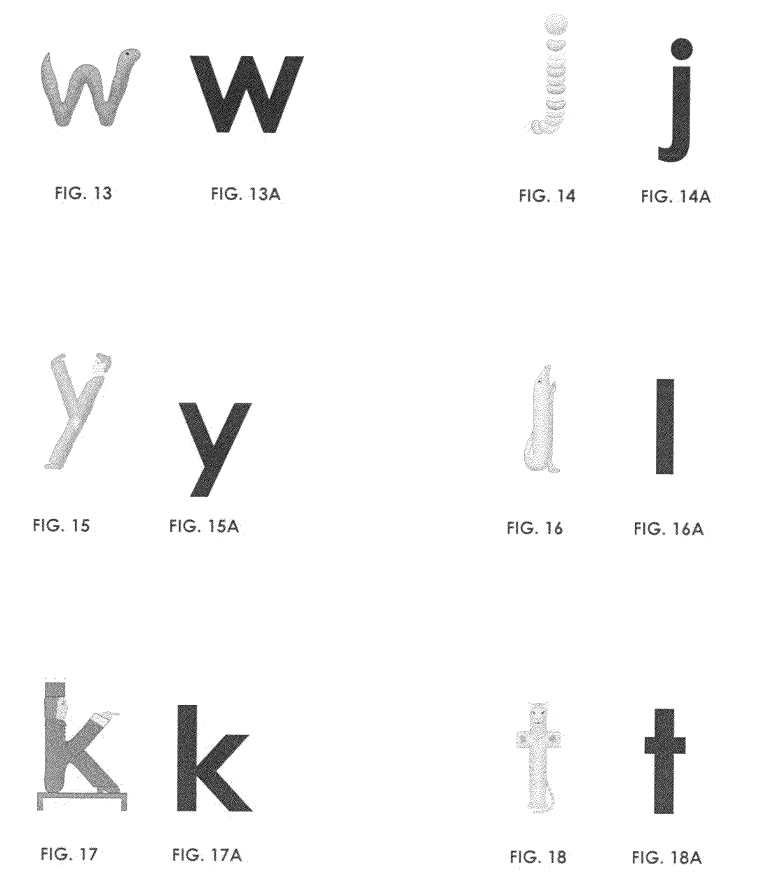

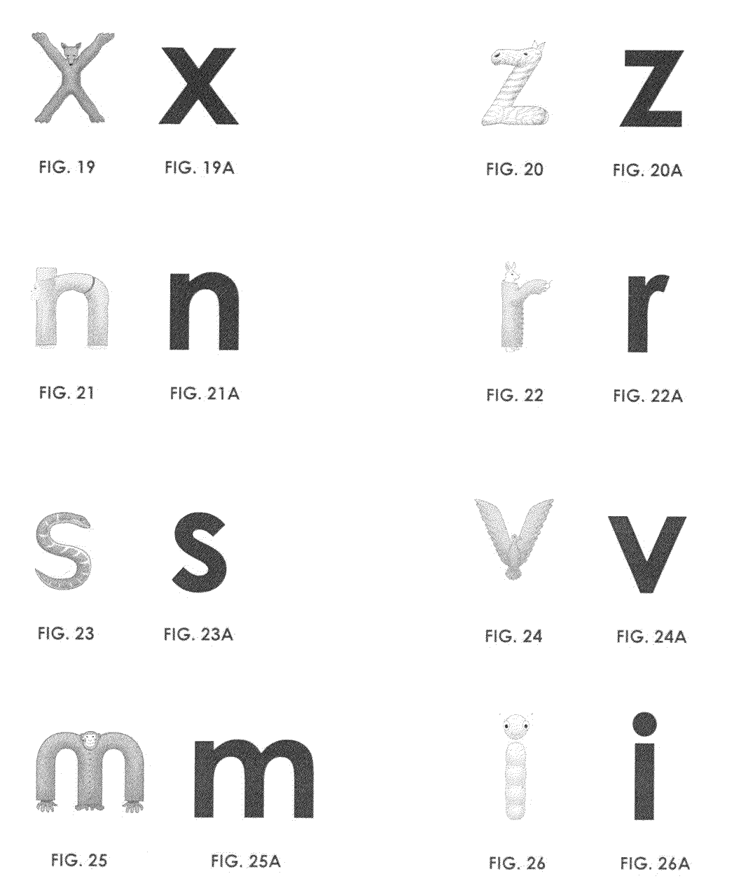

### DETAILED DESCRIPTION OF THE INVENTION

Among the existing methods of teaching reading and writing, the best method is the Phonetic Method. In order to read a word phonetically, the child has to a) recognize the letter shapes, b) say their basic sounds one by one and c) blend those sounds together. In order to write a word, the child needs to a) segment the word into its sounds orally and b) write the symbols of those sounds on paper.

Sound blending and word segmenting are two skills. Their learning is easy because it is based on hearing and needs only practice. But learning and remembering the letter shapes and their basic sounds are a big problem, because the letter shapes and especially their sounds are abstract to young children, therefore extremely difficult to learn.

The problem could have been solved if one had eliminated the abstract nature of the letter shapes and sounds by having invented tangible bases for them. That is exactly what we have done. We have invented 26 letter shaped animals/objects. Each animal/object physically looks like a letter and the first sound of each animal/object name and the basic sound of the letter that each animal looks like are the same. We have made two sets of flash cards. One set comprises 26 cards with one colorful letter shaped animal/object picture on each card and the second set comprises 26 flash cards with one regular letter on each card. With these two sets of cards we teach 26 letter shapes and their 26 basic sounds to Kindergarten and Pre-Kindergarten children in a very short time in the following three steps:

### Step 1

The teacher displays all 26 animal/object shaped letter cards and teaches the names of all 26 animals/objects. For example:

alligator [symbol] bear [symbol] caterpillar [symbol] duck [symbol] elephant [symbol] etc.

### Step 2

The teacher displays all the animal/object shaped letter cards and the regular letter cards in pairs like the samples below: [symbol] [symbol] [symbol] etc.

The teacher tells the students that both the colorful picture and the black picture of each pair are those of the same “animal” or object and they have the same shape and the same name. The only difference is that the black “animal” doesn't have the details and is not colorful.

So the name of these two animals is alligator [symbol] Likewise, the name of these two animals is duck [symbol] The name of these two is fish [symbol] and the name of these two is king [symbol] etc.

### Step 3

The teacher explains to the students that each animal/object has a long name and a short name. (The short name is the first sound of the long name).

For example:

The long name of these two [symbol] is alligator and their short name is [a].

So the short name of bear [symbol] is [b], the short name of caterpillar [symbol] is [k], duck is =[d] [symbol] gorilla [g] [symbol] tiger=[t] [symbol] king=[k] [symbol] fish=[f] [symbol] monkey=[m] [symbol] etc.

Fox [symbol] is an exception. Its short name is its last two sounds [ks]. After teaching all the short names, the teacher removes the colorful “animals” and objects and lets the children say the short names of the black “animals”; like [symbol] [k], [symbol] [d], [symbol] [t], [symbol] [g], [symbol] [f], [symbol] [m], etc.

As you see, by learning the shapes and the short names of the “animals” and objects, children actually learn the shapes and the basic sounds of all the letters.

The Invention makes the learning material so easy and fun that children don't even realize that they are learning the letter shapes and sounds. Children think they are learning the shapes and the short names of animals or objects. Our Invention has two major advantages: a) It eliminates the abstract nature of the letter shapes and sounds in Kindergarten, making it possible to teach the letter shapes, their basic sounds, and basic reading and writing program easily and in a very short time and b) it makes it possible to teach the letter shapes, their basic sounds, and the same basic reading and writing program, which consists of more than 160 words, in Pre-Kindergarten as well.

Testing our Invention in a Pre-Kindergarten class, where the majority of the students had average or below average ability, showed that all the children successfully learned the letter shapes and their basic sounds in two months, and the whole basic reading and writing program in seven months. Three private students of the same age learned the whole program in three months. Unbelievable, but these are the facts.

1. A drawing of an animal or an object which physically looks like a letter and the first sound of that animal or object name and the basic sound of that letter are the same.

2. A drawing of an animal or an object which physically looks like a letter as in claim 1, and the last sound of that animal or object name and the basic sound of that letter are the same.

3. An animal or an object made of some plastic or hard material which physically looks like a letter as in claim 1, and the first sound of that animal or object name and the basic sound of that letter are the same.

4. An animal or an object made of some plastic or hard material which physically looks like a letter as in claim 1, and the last sound of that animal or object name and the basic sound of that letter are the same.

5. Any cartoon animal or object which in a paused or moving position looks like a letter as in claim 1, and audibly expresses the first sound of its own name (as his/her name), which is also the basic sound of that letter.

6. Any cartoon animal or object which in a paused or moving position looks like a letter as in claim 1, and a human voice audibly expresses the first sound of that animal name (as the short version of that animal's name), which is also the basic sound of that letter.
